(19) United States
(12) Patent Application Publication
(10) Pub. No.: US 2007/0209441 A1
(43) Pub. Date: Sep. 13, 2007

(54) Pressure sensor device

(76) Inventors: Horst Gunther, Nurnberg (DE); Oliver Feirer, Nurnberg (DE)

Correspondence Address: BACHMAN & LAPOINTE, P.C., 900 CHAPEL STREET, SUITE 1201, NEW HAVEN, CT, 06510, US

(21) Appl. No.: 11/712,658

(22) Filed: Mar. 1, 2007

(30) Foreign Application Priority Data
Mar. 2, 2006 (DE) 20 2006 003 446.3

(51) Int. Cl. G01L 19/08

(52) U.S. Cl. 73/712

(57) ABSTRACT

A pressure sensor device with a housing including an electrical contact plug section which provides a pressure channel for a pressure sensor accommodated in the housing. The housing is constructed in multiple parts comprising a first housing section with the contact plug section seated in one piece thereon and a second housing section forming the pressure channel constructed to act in conjunction with the first housing section. A pressure recording unit built in modular fashion and carrying the pressure sensor is constructed in such a way that in an operationally useful state of connection of the first and of the second housing section the pressure sensor unit is fixed between sections of both housing sections. The pressure recording unit possesses a connecting unit which is connected in cordless electrically conductive manner to a contact pin held in the contact plug section.

### BACKGROUND

(1) Field of the Invention

The present device relates to a pressure senor device according to the introductory part of the main claim.

(2) Prior Art

Such a device is generally known from the state of the art, that of the automotive engineering sector for instance, and possesses a housing having a contact plug section, wherein the pins or contact elements of the contact plug section are then connected via suitable connectors, in particular cables, to a pressure sensor electronic system accommodated in the housing. Through a pressure channel formed in the housing a pressure sensor as the actual signalling element is connected to the medium to be measured and an output signal from the pressure sensor is then passed by means of the evaluating electronics and via the contact plug to downstream units, the central motor vehicle control electronics for instance.

Depending on the field of application such devices forming the generic category are produced in very high piece numbers, wherein, apart from aspects of quality assurance in production, primarily the required technical costs of production are of importance.

Not least the need to connect the respective contact pins of the plug section via (suitably soldered or crimped) wire connections to the sensor electronics in conventional fashion gives rise to considerable production costs so that in particular from the point of view of large-scale production there is a need for optimisation.

### SUMMARY OF THE INVENTION

Accordingly, it is an object of the present invention to improve a pressure sensor device according to the introductory part of the main claim with regard to its production technology, in particular to ensure a simpler, potentially more reliable and lower-cost electric connection between the contact elements of the cable plug section and the pressure sensor or the pressure sensor electronics, wherein such a device should be suitable in particular for large-scale production.

This task is solved by the pressure sensor device having the characteristics of the main claim; advantageous refinements of the invention are described in the subsidiary claims.

Advantageously, according to the invention the housing is first of all built in multiple parts with a first and a second housing section, wherein these are constructed in such a way that in the assembled state the pressure sensor unit (containing the actual pressure sensor and if need be associated electronics) can be held fixed between them. In this way not only assembly can be simplified but also such a structural implementation also ensures firm seating of the pressure sensor unit.

Also advantageously the pressure recorder unit has allocated to it a connecting unit which although according to a refinement is provided outside of a housing or support unit of the pressure recorder unit is connected to the latter mechanically and electrically. Such a preferably plate-shaped or board-shaped connecting unit then in structurally simple, but nevertheless secure fashion in interconnection terms, allows a reliable, wireless connection to be established between the contact pins of the contact plug section and the electronics or the pressure sensor in the pressure sensor unit.

Stated more precisely and according to a preferred refinement of the invention such a plate-shaped connecting unit is connected mechanically to the pressure sensor unit in such a way that a housing section (built of plastic or metal) establishes the mechanical connection between the two elements and on a conductor surface of the connecting unit can then in the assembled state of the arrangement encounter in contact-making manner at least one contact pin and according to a refinement be joined there in conductive manner by soldering, welding and/or gluing.

Such a procedure proposed by the invention in this way allows not only extremely simple and readily automated assembly, but also the contact making made possible in this way is optimised in electrical and mechanical terms.

As a result it is possible in this way by means of the present invention to provide a pressure sensor device which is preferably suitable for use in the motor vehicle field, but is also employable in principle in numerous other fields of application.

Depending on the mechanical and structural design of the housing and the sealing and/or securing elements provided according to,the refinements various classes of protection can be realised and furthermore stability in electromagnetic compatibility as well as security against polarity inversion and/or overvoltage. While it is additionally preferable, as described in the following exemplified embodiment, to implement typical cable and plug standards by the contact plug section according to the invention, any kinds of configuration fall within the scope of the invention in just the same way as the electrical and signalling design of the pressure sensor device by the provision of suitable evaluating and processing technology for the signals output by the pressure sensor either inside the unit itself or alternatively as part of externally connected electronic systems, the motor vehicle electronics for instance.

### BRIEF DESCRIPTION OF THE DRAWINGS

Other advantages, characteristics and details of the invention emerge from the following description of a preferred exemplified embodiment with reference to the drawing. In the single figure these show:

THE FIGURE is a side sectional view through the pressure sensor device according to the invention as implemented in a first preferred exemplified embodiment of the invention.

### DETAILED DESCRIPTION OF THE PREFERRED EMBODIMENT(S)

A flat housing formed by an upper housing section 10 and a lower housing section 12 built in the form of a connecting plate possesses in the region of the upper housing section 10 a contact plug section 14 which in the exemplified embodiment shown is designed in accordance with DIN 72 585.

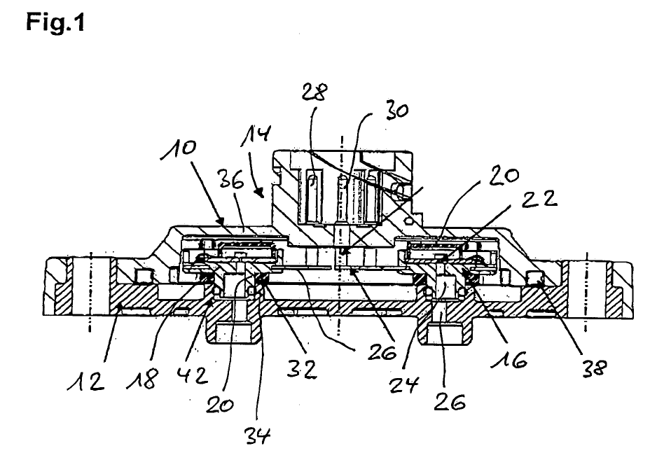

The housing shown in the assembled state in FIG. 1 affords in its interior space for accommodating two pressure sensor units 16, 18, wherein each of this pair of pressure sensor units is itself in turn accommodated in pressure-tight manner in a support housing 20 (made of a suitably injectable plastic material). More accurately each of these support housings 20 contains an otherwise known pressure sensor 22 as signal-emitting element, additionally connected if need be to a first amplifier stage or other evaluation electronics. The pressure admission side of each pressure sensor is open towards a pressure channel which directed downwards in FIG. 1 and is constructed, on the one hand, by an opening 24 in the base of the support housings 20 and additionally by a pressure channel opening 26 in the lower housing section 12 so that a pressure applied to the base and to be measured by the pressure sensor units 16, 18 can be transmitted upwards to the sensors (held in pressure-tight housings 20).

Projecting laterally from the support housings 20 in each case each of the pressure sensor units 16, 18 possesses a connecting device in the form of a contact board 26 which in the fashion shown in FIG. 1 establishes the electric contact to the contact pins 28, 30 of the contact plug section 14. Stated more precisely, the downwardly directed end sections of the contact pins 28, 30 engage on these suitably allocated conductor track sections of the contact printed circuit board 26 and are joined there by means of suitable contact methods, in particular soldering or welding. The conductor tracks are then connected in the region of the support housing 20, again by suitable contact methods, to the electronics of the pressure sensor units 16, 18, typically by bonding or a comparable contact method, preferably one readily capable of automation.

As the overall view in FIG. 1 makes clear, it is possible in this fashion not only to establish not only an electrically very reliable connection capable of automated production but also this connection can be placed under mechanical load and is mechanically reliable. That is to say, as FIG. 1 makes clear, the pressure sensor units 16, 18 are held in the manner shown between the upper housing section and the lower housing section 12, whereby elastic elements 32 make it possible that by means of suitable projections 34 in the lower housing section 12 an elastic pretensioning force on the pressure sensor units is pushed against flat sides 36 of the upper housing section 10 as a buttress. In this way not only are any assembly tolerances well compensated, but also there is advantageous damping of vibrations countering any effects when the vehicle is in use.

In the exemplified embodiment shown the entire sensor housing is sealed by a sealing ring 38 which in the outer region runs round the disk-shaped arrangement and is held in a suitable annular groove in the upper housing section 10. Pressure channel seals 42 in the exemplified embodiment shown ensure pressure-tight sealing of the pressure channels 24, 26 with respect to the interior of the housing.

This results in a pressure sensor arrangement in which both the individual components designed in modular style as well as the entire arrangement can be joined together in fully automated manner so that in particular labour-intensive assembly steps, as known from the state of the art—especially the fault-susceptible fitting of wires—can be completely avoided. Accordingly, the device provided in this way is particularly suitable for use in environments exposed to vibration, dirt and/or moisture, as is the case in the automotive sector; in principle, however, almost any other field of application is conceivable.

It should also be noted that the present invention is not restricted to the exemplified embodiment shown, on the contrary the number of pressure sensor units, for instance, is dependent on the purpose in question as is the design of the pressure sensor units themselves (that is either bonded in pressure-tight manner in a support made of plastic or metal, as in the present exemplified embodiment, or built up in modular fashion or discretely in a different way), and further, numerous alternative contact possibilities between the contact printed circuit board and the pressure sensor electronics in the support housing are conceivable, and also the flat structural form shown in the exemplified embodiment would be designed in suitably different fashion depending on the intended purpose.

1-9. (canceled)

10. Pressure sensor device with a housing comprising:
an electrical contact plug section which provides a pressure channel for a pressure sensor accommodated in the housing;
the housing being constructed in multiple parts and comprising a first housing section with the contact plug section seated in one piece thereon and a second housing section forming the pressure channel constructed to act in conjunction with the first housing section;
a pressure recording unit built in modular fashion and carrying the pressure sensor, said pressure recording unit being constructed in such a way that in an operationally useful state of connection of the first and second housing sections the pressure sensor unit is fixed between sections of both housing sections; and
the pressure recording unit possessing a connecting unit which is connected without cables in an electrically conductive manner to a contact pin held in the contact plug section.

11. The pressure sensor device according to claim 10, wherein the pressure recording unit forms a pressure-tight support housing for the pressure sensor on the outside of which the connecting unit is seated.

12. The pressure sensor device according to claim 11, wherein a planar connecting unit is enclosed in one piece, at least in sections, by material of the support housing.

13. The pressure sensor device according to claim 12, wherein the planar connecting unit encapsulated by injection moulding by a plastic material of the support housing.

14. The pressure sensor device according to claim 10, wherein the connecting unit is built like a printed circuit board.

15. The pressure sensor device according to claim 12, wherein an electric connection between the connecting unit and at least one of the pressure sensor and an electronic system allocated to the pressure sensor in the support housing is realized by a bonded joint.

16. The pressure sensor device according to claim 10, wherein a cordless, electrically conductive connection between the connecting unit and the contact pin is constructed by at least one of soldering, welding and bonding.

17. The pressure sensor device according to claim 10, wherein the first and second housing sections are joined in sealed fashion to one another by an all-round seal.

18. The pressure sensor device according to claim 10, wherein a gripping section of a first one of the first and second housing section acts via an intervening elastic element on the pressure sensor unit against an associated gripping section of a second one of the second and first housing section as a buttress.

19. The pressure sensor device according to claim 10, wherein the housing is constructed and suitable for assembly on a vehicle frame.
